(19) United States
(12) Patent Application Publication
(10) Pub. No.: US 2017/0280862 A1
(43) Pub. Date: Oct. 5, 2017

(54) METHOD, DEVICE AND KIT FOR SECURING CELL PHONE IN A POCKET DURING ACTIVITY

(71) Applicant: Matthew A. BLACKWOOD, Alexandria, VA (US)

(72) Inventor: Matthew A. BLACKWOOD, Alexandria, VA (US)

(21) Appl. No.: 15/388,202

(22) Filed: Dec. 22, 2016

Related U.S. Application Data
(60) Provisional application No. 62/316,727, filed on Apr. 1, 2016.

(51) Int. Cl. A45F 5/00; H04B 1/3827

(52) U.S. Cl. CPC A45F 5/00; H04B 1/385; A45F 2005/008; H04B 2001/3855

(57) ABSTRACT

A cell phone holding device includes a belt that is adjustable in length and has two opposing ends connectable together, the belt sized for surrounding a user's thigh. A stretchable loop is attached to the belt, the loop having an opening sized to receive a cell phone-containing pocket, the pocket in clothing worn by the user, the stretchable loop configured to hold the pocket against the belt but not support the weight of the cell phone. The loop including means to expand the opening to receive the cell-phone containing pocket. The loop can also include a material to grab the pocket to keep it in the loop if the phone should be removed. The device can also be in kit form using a stopper to keep the phone in the pocket after the pocket is received by the stretchable loop. A method of using the device is also disclosed.

This application claims priority from provisional patent application 62/290,059 filed on Feb. 2, 2016 and provisional patent application 62/316,727 filed on Apr. 1, 2016, both of which are incorporated by reference in their entirety.

### FIELD OF THE INVENTION

A cell phone holding device includes a belt that is adjustable in length and has two opposing ends connectable together, the belt sized for surrounding a thigh of a user. A stretchable loop is attached to the belt, the loop having an opening sized to receive a cell phone-containing pocket for securing the cell phone in the pocket.

### BACKGROUND ART

Smart phones have become part of almost every activity that people undertake; exercise is no exception. People carry and use their smart phones for numerous reasons while they exercise including to listen to music and to track their movement with GPS or a pedometer. In addition, many individuals carry their phone with them simply to communicate, navigate, for emergencies, to take pictures, for work, or social media purposes. People use various contraptions and methods to carry their phone while exercising: some utilize an arm or waist mounted device; others hold their phone in their hand; and many simply place their phone in the pocket of their lower garment. However, when your phone is in your pocket during exercise it bounces against your leg and is prone to fall out. Those that use headphones with a cord may notice that the bouncing of the phone causes stress on the headphone jack which will eventually loosen the jack. This causes distortion of the music and may eventually lead to the headphone jack or the headphone cord ceasing to functioning all together.

### SUMMARY OF THE INVENTION

The invention solves this problem for anyone that places their phone in their pocket while exercising or engaging in any activity. The invention comfortably secures the phone against the leg of the user while still allowing the phone to be easily accessible through the pocket of the user's lower garment. This allows for convenient use of the phone as necessary during exercise, as it can be quickly removed and replaced with one hand.

Hidden underneath the user's lower garment, the device is not visually or physically obtrusive. Since the user's own pocket support the weight of the phone, the inventive device does not slip down the leg, nor does it have to be designed, e.g., be excessively tight around the wearer's leg, to support the weight of the phone.

When your phone is in your pocket, it is in the way or in risk of being damaged when performing exercises where a barbell rests against your upper thigh area during the movement. When you perform exercises where you lie facing the ground, such as push-ups or burpees, your weight lands on your phone. The invention allows the user to position the phone on the side or front of the leg as necessary, depending on which exercise is being performed. Any exercise where an individual lies on their back, including exercises involving a bench or the many variations of sit-ups, their phone may fall out of their pocket. With the use of the inventive device, the user will maintain all of the advantages of having their phone in their pocket, without the phone bouncing, falling out, or causing damage to the headphone jack and cord.

More particularly, the cell phone holding device includes a belt that is adjustable in length and has two opposing ends connectable together, the belt sized for surrounding a thigh of a user. A stretchable loop is attached to the belt, the loop having an opening sized to receive a cell phone-containing pocket, the pocket in clothing worn by the user, the stretchable loop configured to hold the pocket against the belt but not support the weight of the cell phone. The loop has means to expand the opening to receive the cell-phone containing pocket.

The belt can be stretchable and include a buckle to connect the opposing ends together. The expanding means is one of a tab on the loop, a raised member on the tab or a raised member on the loop, grasping of the tab or raised member allowing expansion of the opening. The belt can have a pair of stretchable loops for accommodating different sized cell phones.

The invention also includes a cell phone holding kit comprising the belt and a stopper. The stopper is sized larger than the opening and intended to be inserted into a bottom of the pocket and past the stretchable loop to keep the pocket in the stretchable loop when the cell phone may be removed, the stopper optionally having a slot to be attached to the belt for storage purposes.

The device can also include a pocket adhering material, the pocket adhering material located on an inner surface of the stretchable loop so as to be in contact with a surface of the pocket. The pocket adhering material adheres to a portion of the pocket to facilitate phone removal from the pocket while keeping the pocket in the stretchable loop. The pocket adhering material can be the hooks of a hook and loop fastening system of a textured material.

The invention also includes a method of securing a cell phone during activity comprising providing the cell phone holding device and placing the belt thereof around a user's thigh. The opening of the loop is expanded to allow insertion of a cell-phone containing pocket into the loop. In another mode, the stopper can be inserted into the pocket, the stopper keeping the pocket in the loop if the cell phone is removed from the pocket. The loop can have a tab on it, a raised member on the loop or the tab, and the tab or raised member is grasped to open the loop. The pocket adhering material can also be employed to assist in retaining the pocket in the loop during cell phone removal.

### BRIEF DESCRIPTION OF THE DRAWINGS

FIGS. 1A and 1B show an example of the inventive device in kit form.

FIG. 2 shows the inventive device of FIG. 1 in an exemplary use.

FIGS. 3A-C a variation on the stopper of the kit of the invention in three different views.

FIG. 4 shows the device of FIG. 1 with two bands for holding phones of different sizes.

FIGS. 5A-5E illustrate different means for expanding the opening of the loop of the holding device.

FIG. 6 shows an alternative embodiment to the device of FIG. 1.

FIG. 7 shows another embodiment of the belt of FIG. 1.

FIGS. 8A-8C show examples of materials designed to grab a pocket when in the loop of the band of FIG. 7.

FIG. 9 is shows an alternative embodiment to the belt of FIG. 7.

### DETAILED DESCRIPTION OF THE INVENTION

While there are several other devices and methods of securing a phone during exercise available, they have disadvantages that the invention alleviates. Arm mounted devices support the entire weight of the phone with the elastic band; the band has to be tight in order to keep the phone from slipping down the arm. Furthermore, having the device attached to your arm is restrictive, and it may get in the way when performing upper-body exercises. Since the phone is held within a compartment, removing and replacing the device can be difficult. Many individuals use a protective case for their phone, and due to the size of the compartment, it will have to be removed from that case before use. Finally, many do not like the look of having the phone on their arm, and it will cause an undesirable tan line when exercising outside.

Waist mounted devices have some of the same disadvantages. It can be difficult to remove the phone, with many having a zippered compartment requiring the use of two hands to open or close. Also, they are not visually appealing or fashionable to many, having the appearance of a fanny-pack. The inventive device creates a new and convenient option for those that have experienced these problems with other devices.

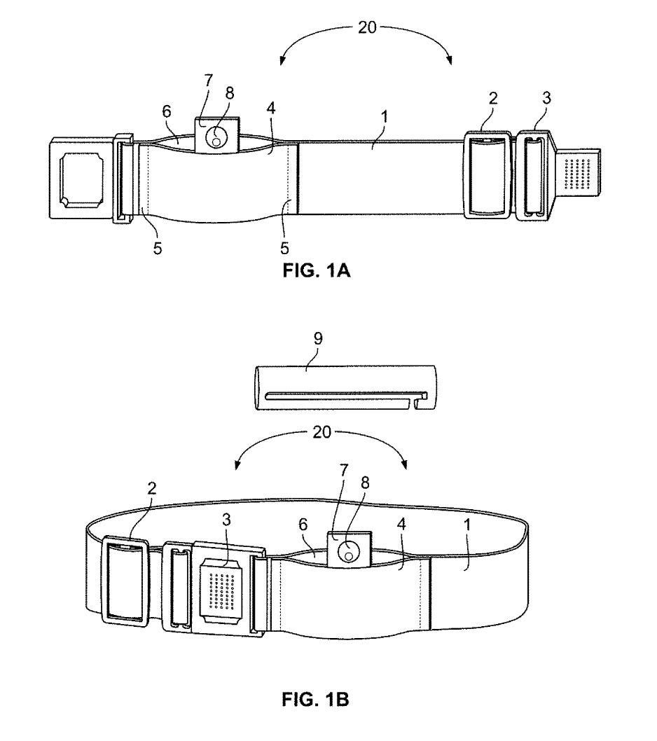

FIGS. 1A and 16 show one embodiment of the invention. FIG. 1A shows the device with its two opposing ends (11) free and FIG. 1B shows the device (10) with its ends (11) connected. The device (20) includes the following:

An elastic, or partially elastic, band (1) that is designed to go around the mid to upper thigh of the wearer. The width of the band may vary, but ideally the width is approximately 2 inches. The length of the band is adjustable, through various means including adjustable straps and clips (2) or Velcro, allowing it to fit snugly around the thigh of the wearer.

The band is secured around the leg through the use of a plastic, quick-release buckle (3) that allows the wearer to quickly and easily put-on or remove the band. Of course, any type of connector could be used to connect the opposing free ends of the band (1).

The band can be composed of an elastic, breathable, durable, non-abrasive material to withstand extensive use during vigorous athletic activity, while causing minimal discomfort or irritation to the wearer due to friction or heat.

A second elastic band (4) is attached to the outside of the first band (1). The second band is attached at two points (5), which can be approximately two inches apart, or the width of a smart phone apart. The second band is hemmed or otherwise attached at the two points along its entire width. This creates a “loop” (6) between the first and second bands in which a smart phone will snugly fit. The second band (4) can be attached to the band (1) in any manner and stitching is just one example of an attachment mode. The configuration of the second band is such that it does not have to be made in a way to support the weight of the phone. The band (4) only needs to be sized so that it can receive a phone-containing pocket and the stopper if the stopper is used. Therefore, no tightening means are required in connection with the band (4) as the band (4) does not have to support the weight of the phone. The band does not have be designed such that the opening formed by an elastic band would be much smaller than the phone-containing pocket; after the band is stretched to receive the phone-containing pocket, the compression of the band around the phone-containing pocket does not have to be capable of holding the phone without a pocket. Thus, the band opening can be made large enough so that only minimal expansion is necessary to receive the phone-containing pocket and the band merely holds the pocket in place against the leg during activity; the pocket of the user's lower athlete garment supports all of the vertical weight of the phone.

The second band can have a pull tab (7) with a raised attachment (8) that allows the wearer to easily locate the tab, and the top edge of the second band. In another iteration, the raised attachment (8) can be directly affixed to the second band (4). A further iteration, the second band (4) can be composed of a more rigid material that makes it protrude from the first band (1) allowing the user to find, and grasp it, through their athletic garment. By grasping the pull tab (7) via the raised attachment (8) through the athletic garment, the wearer will be able to easily create separation between the first and second bands, i.e., create the loop, allowing the wearer to easily push the phone and pocket through the space between the first and second band. The pull tab (7) can be used alone or in combination with the raised attachment (8) and the attachment (8) can take on any form that facilitates grasping the pull tab (7). In the alternative, the second band (4) can be made without the pull tab (7) and/or raised attachment (8) and a user would just have to grab the second band (4) to enlarge the opening to allow for pocket and phone insertion therein.

While a pull tab (7) with or without a raised attachment (8) can be used with the second band (4), any means for expanding the opening of the second band can be used to allow the phone-containing pocket to be inserted into the second band (4). More particularly, the second band (4) can have any kind of a member, e.g., a tab attached to the second band (4), a raised member attached to the tab or directly to the second band (4), or combinations thereof that would make it easier for a user to grab the second band (4) to expand its opening for a phone-containing pocket insertion.

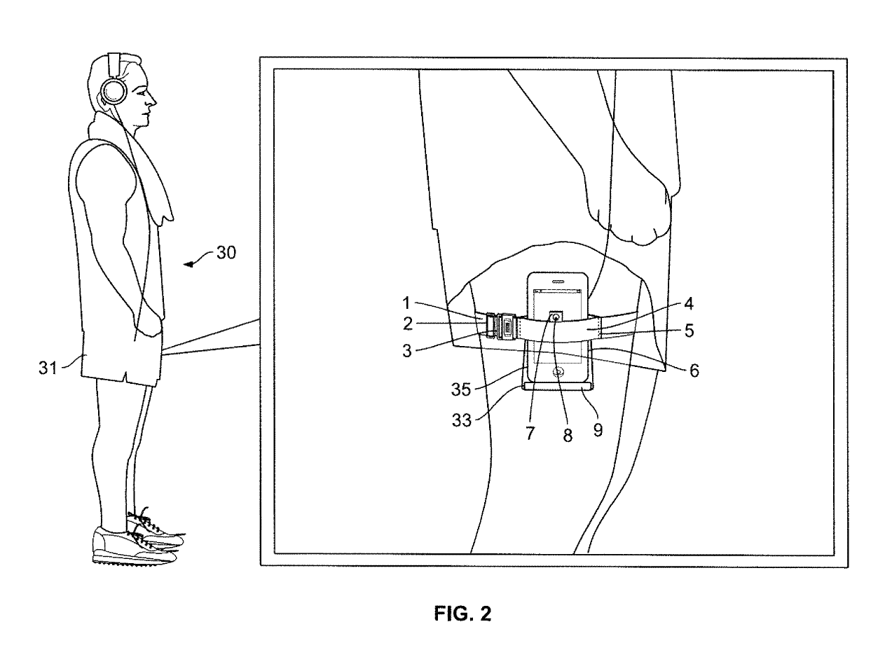

Another aspect of the invention is a kit that employs the device (20) in combination with a stopper (9), which can be plastic, rubber, or foam. Ideally the stopper (9) is composed of a soft material that will not scratch the surface of the phone or break the screen of the phone if the stopper (9) gets between an object or the ground and the phone. The stopper (9) is designed to go in the pocket of the wearer's lower garment in which the phone will be placed. The stopper (9) is placed in the user's pocket, and pushed through the space or opening created by the second band (4), until it sits in the bottom of the pocket, below the loop created by the bands. The stopper keeps the pocket lining held in place between the bands when the user pulls the phone out of his pocket for use, which allows the user to easily push the phone between the elastic bands when replacing it. This helps facilitate the user being able to remove and replace the phone with one hand. Preferably, the stopper is sized to be larger than the opening created by the second band (4) so as to retain pocket in the opening. The stopper can have virtually any shape that would accomplish the purpose of keeping the pocket in the opening created by the second band. Ideally it is of a shape that will not cause discomfort if pressed against the leg of the user. FIG. 2 shows the device in use. A user (30) is wearing athletic shorts (31) with a pocket (33). The pocket (33) is shown cutaway with a phone (35) in the pocket and the pocket and phone being secured using the band (4). The stopper (9) is shown in the bottom of the pocket to keep the pocket from slipping out of the band (4) if the phone should be removed.

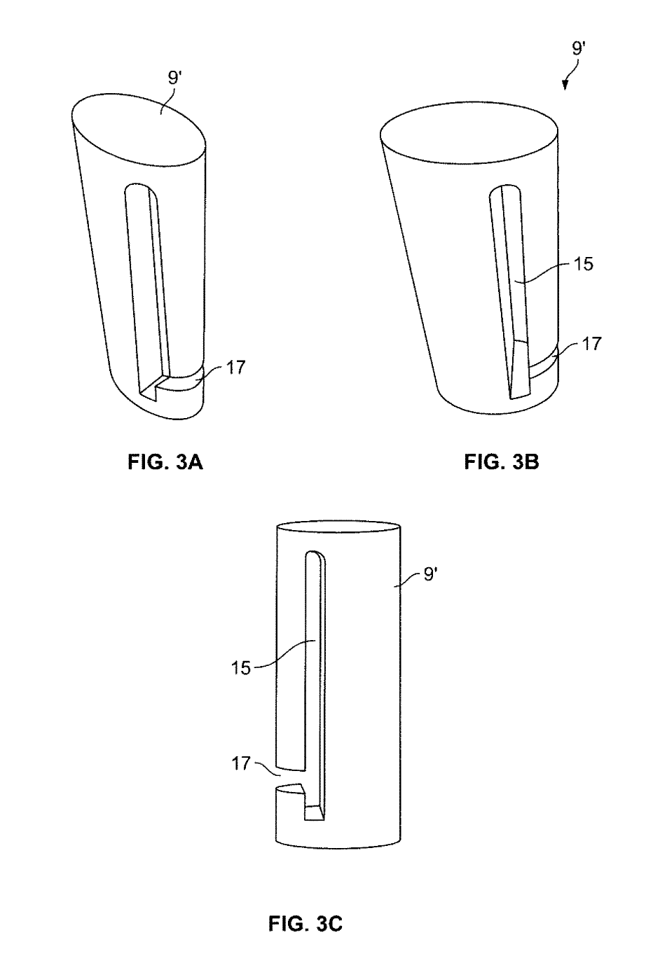

FIGS. 3A-C show three different views of a stopper (9′) with a slot (15). The slot (15) includes an opening (17) and is sized to receive the first band (1) so that the stopper (9′) can be held on the band (1) when not in use. The opening (17) allows for insertion of the band (1) into the slot (15).

Referring to FIG. 4, the band (1) can include two bands (4) and (4′), each of different sizes to accommodate different types of phones. In a further embodiment, the band (4) could be made adjustable in length like band (1) to accommodate different sized phones.

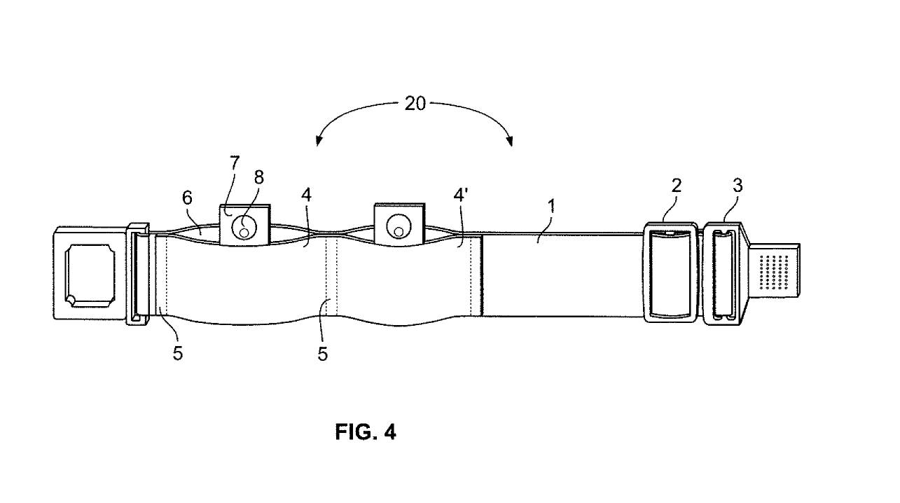

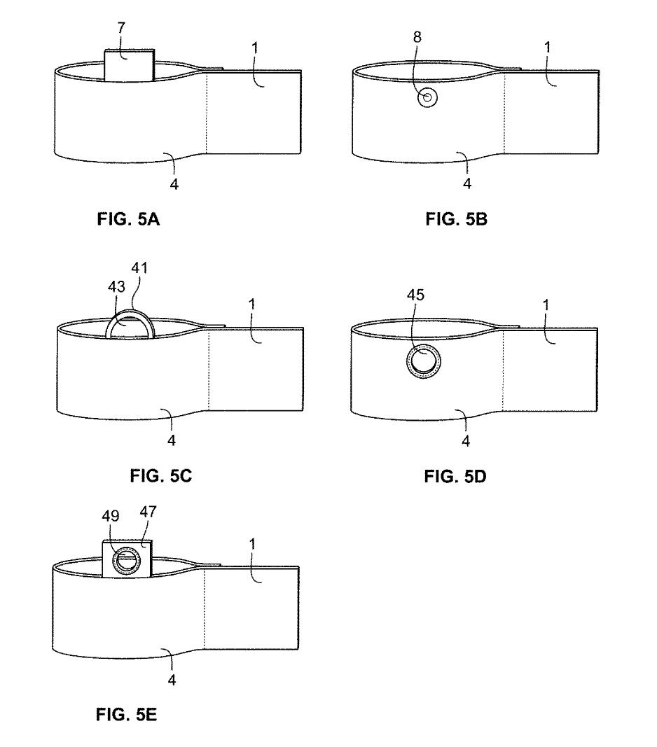

FIGS. 5A-5E shows alternative means for expanding of the opening formed by the second band (4). The second band (4) is shown with just a portion of the first band (1). In FIG. 5A, the tab (7) is shown without any attachment. The tab 7 can be merely an extension of the material of the second band (4).

FIG. 5B shows the raised attachment (8) located on the second band (4).

FIG. 5C, shows a loop (41) that extends from a top edge of the second band (4). The loop (41) has an opening (43) that allows a user to grab the loop (41) to expand the second band (4). Preferably, the loop is made of a rigid material to facilitate gripping it and affixed to the second band (4) in any known way.

FIG. 5D shows the second band (4) with a through opening (45) in it. The through opening (45) provides a way to grip the second band (4) than just grabbing the band itself. The through opening (45) could be stitched opening in the material of the second band (4).

FIG. 5E shows a tab (47) with a through opening (49) in it, the tab (47) similar to the tab of FIG. 5A and the through opening (49) similar to the through opening (45) of FIG. 5D.

The second band (4) can be made in any way that provides the opening to receive the phone-containing pocket. It could be a segment of the first band, wherein the segment passes through a square ring and is folded over the first band and attached to the first band in a permanent mode, e.g., stitching, or a movable mode, wherein the end of the segment is clamped to the first band to keep the end of the segment in place. In the movable mode, the size of the opening for the loop of the second band can vary depending on the size of the phone being carried. The band (4) can be made of material separate from the first band (1) and attached thereto in any known fashion, either in a fixed attachment or a movable one.

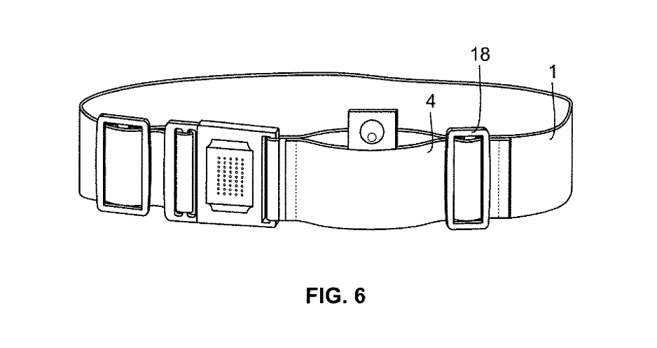

FIG. 6 shows an example of a device, wherein the second loop can be varied in size, through the use of a clip (18). An end of the band (4) is attached to the clip (18), which is in turn movably clamped to the band (1). By loosening the clip (18), the user can slide it back and forth along the length of the first band (1), thereby varying the size of the loop created by the second band (4). The clip (18) can also serves two other purposes. The clip (18) can be made of a rigid material like a plastic or metal, that allows the user to feel it through athletic wearing apparel, thus indicating where the edge of the second loop is. Knowing where the edges of the second loop are help the user slide the phone through the loop. Furthermore, the rigid clip (18) will give the band (4) additional structure, acting as a sort of skeleton for the band. This will keep the band (4) from collapsing upon itself, or folding over itself, when the user is attempting to push the phone through the loop.

As an alternative to the stopper embodiment, the second band (4) can include a material on an inner surface thereof that is configured to grip or grab the pocket once the pocket passes through the second band (4). The material can be adhered to the inner surface in any manner, stitching, adhesives, mechanical fastening or a combination thereof.

The material can be any material that, when in contact with the outer surface of the pocket will grip or grab the pocket and hold it in place in the second band (4) when the phone is removed therefrom. Examples include the hooks from a hook and loop fastening system, e.g., Velcro®, a textured material that would be configured to grab the pocket surface.

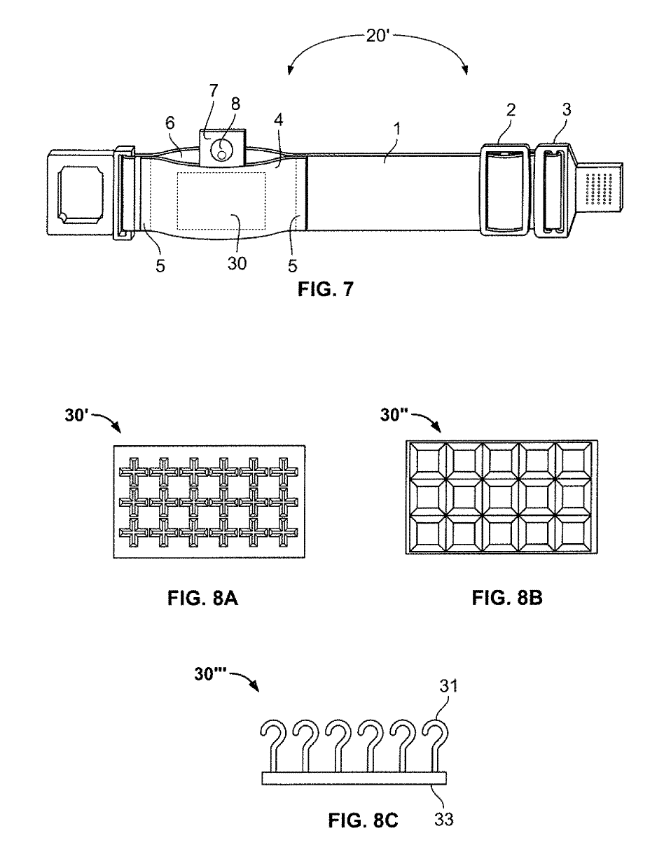

FIG. 7 shows another version of the belt 20′ as an illustration of the band of FIG. 1 with the pocket adhering material 30 affixed to an inner surface of the second band (4). FIGS. 8A and 8B shows examples of textured materials as the material 30′ and 30″. The materials in FIGS. 8A and 8B can be made of an elastic material like rubber and can further have a coarse surface texture to enhance the grabbing of the pocket. FIG. 8C shows another material as 30′″. This material is a schematic view of hooks 31 and a base 33 from a hook and loop fastener system as the material for the inner surface of the second band (4).

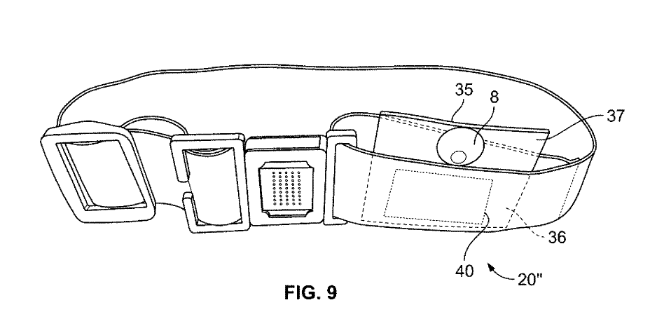

FIG. 9 is shows a variation of the belt according to the FIG. 7, the variation designated as 20″. As seen in the FIG. 9 illustration, the material (30) designed to grip the pocket can be combined with the tab (7) that is utilized to assist the user in opening the “loop” to insert the phone. When utilizing a rigid material as the material (30) and the same rigid material for the tab, the material (30) and the tab (7) can be one continuous piece of material 35. One part 36 disposed inside the opening formed by the second band (4) functions to grab the pocket and the other part 37 of the material 35 extends out of the loop and functions like the tab (7). The material can be attached in any way and stitching 40 is shown in FIG. 9 as one example. This arrangement further assists the user to insert their phone through the loop. When the user puts their phone into their pocket and pushes on the backside of the tab (the surface opposite the raised attachment (8)), this action creates separation between the two bands, allowing the user to slide the phone into the opening created by expanding the second band (4).

In the method of use of the band (1) when using the material 30, once the pocket is inserted into the second band (4) with the phone therein, the material grabs the pocket and holds it in place when the phone is removed, akin to the function of the stopper described above.

In this mode of the invention, the stopper is not needed as the material 30 is part of the band (1) and there is no risk of a loss of the material like the stopper.

The material 30 also functions as a spacer to create a space between the pocket and phone and a leg of the user of the device. This minimizes heat transfer from the phone to the user.

The invention also entails a method of using the device (20), including in kit form. The wearer first attaches the first band (1) around his thigh, underneath a lower outer garment with pockets, such as athletic shorts or pants. The wearer then places the stopper (9) (if available) into the pocket of the athletic garment and then locates the pull tab (7) and raised attachment (8). After gently pulling on the tab to create space between the first and second bands, the user then pushes both the phone and the pocket of the garment through the loop created by the first and second bands. The user will then place his phone in his pocket, while using a finger to locate the opening created where the pocket lining goes through the loop in the band, and then push the phone into the loop until the bands are snugly fitted around the phone and pocket.

The phone will now be secured in place while in the pocket of the user, held snugly between the elastic bands against the wearer's thigh. This allows the wearer to exercise or participate in athletic activity, such as running, core strength and conditioning programs like Crossfit®, weightlifting, basketball, rowing, or biking, without the phone bouncing against the wearer's leg or falling out of the pocket, while still being able to quickly and easily access the phone through the pocket of the athletic garment.

The invention has a number of advantages as listed below:

The weight of the phone is supported by the pocket of the wearer's outer garment; the band simply holds the phone against the leg of the wearer. Other devices, whether designed to be used around the arm, leg, or waist of the user, are required to support the full weight of the phone. This often results in slippage while exercising or participating in physical activity. Furthermore, the band has to be tight around the appendage to support this weight, making them uncomfortable for some users. Since this device does not support the vertical weight it can be considerably looser without any slippage.

Other leg-worn devices must either be worn over the top of the outer garment or they will not be easily accessible if the shorts or pants extend over the device. Wearing over the top of the undergarment is unsightly, and not being able to access the phone quickly and easily is inconvenient to users that want to be able to change songs, check messages or answer calls, or use their phone for any other reason.

Arm-worn devices are prone to slippage due to supporting the entire weight of the phone. If you are participating in exercise that involves arm or upper body movement, the arm-worn devices may be obstructive and cumbersome. They are also unsightly for some and they may cause undesirable tan lines for those that exercise outside. Arm-worn devices require a user to have to slide the device into a secure compartment, making use of the phone difficult while exercising due to having to pull the phone in and out of the device. Some arm-worn devices incorporate a clear plastic cover, but use of the phone through the cover while on the arm of the user is still difficult.

Waist-worn devices often require the user to place the phone in a separate compartment, making access difficult. They are also unsightly for some and may also be prone to slippage.

Many individuals place their phone in their pocket while utilizing headphones. Over time, movement of the phone in the pocket will cause the headphone jack to become loose, causing distortion of music, and eventually breaking. Similarly, movement of the headphone cord causes wear at the joint where the cord becomes the input jack, causing the headphones to eventually stop working. By securing the device against the leg, much of the movement and wear on the headphone jack and cord is eliminated or reduced, preventing damage to the phone and headphones.

An additional band (4′) can be affixed to the first band (1), different in size from the second band (4), in order to accommodate different sized phones and phones in cases.

The device is easily and comfortably secured around the thigh of the wearer, hidden from view. This allows the user to put it on before beginning exercise or activity, then use the device as necessary during exercise, without having a visibly and physically obtrusive device around an appendage during the exercise when it's is not necessary.

The design of the device allows it to accommodate a wide range of phone sizes, with or without cases, whereas arm-worn devices, for example, generally only accommodate one size of phones without a case.

As such, an invention has been disclosed in terms of preferred embodiments thereof which fulfills each and every one of the objects of the present invention as set forth above and provides a new and improved device and method for carrying a cell phone.

Of course, various changes, modifications and alterations from the teachings of the present invention may be contemplated by those skilled in the art without departing from the intended spirit and scope thereof. It is intended that the present invention only be limited by the terms of the appended claims.

I claim:

1. A cell phone holding device comprising:
a belt that is adjustable in length and has two opposing ends connectable together, the belt sized for surrounding a thigh of a user;
a stretchable loop attached to the belt, the loop having an opening sized to receive a cell phone-containing pocket, the pocket in clothing worn by the user, the stretchable loop configured to hold the pocket against the belt but not support the weight of the cell phone; and
the loop including means to expand the opening to receive the cell-phone containing pocket.

2. The device of claim 1, wherein the belt is stretchable.

3. The device of claim 1, wherein the belt includes a buckle to connect the opposing ends together.

4. The device of claim 1, wherein the expanding means is one of a tab on the loop, a raised member on the tab or a raised member on the loop, grasping of the tab or raised member allowing expansion of the opening.

5. The device of claim 1, wherein the belt has a pair of stretchable loops for accommodating different sized cell phones.

6. A cell phone holding kit comprising:
a belt that is adjustable in length and has two opposing ends connectable together, the belt sized for surrounding a thigh of a user;
a stretchable loop attached to the belt, the loop having an opening sized to receive a cell phone-containing pocket, the pocket in clothing worn by the user, the stretchable loop configured to hold the pocket against the belt but not support the weight of the cell phone; and
the loop including means to expand the opening to receive the cell-phone containing pocket, and
a stopper, the stopper sized larger than the opening and intended to be inserted into a bottom of the pocket and past the stretchable loop to keep the pocket in the stretchable loop when the cell phone may be removed, the stopper optionally having a slot to be attached to the belt for storage purposes.

7. The kit of claim 6, wherein the belt is stretchable.

8. The kit of claim 6, wherein the belt includes a buckle to connect the opposing ends together.

9. The kit of claim 6, wherein the expanding means is one of a tab on the loop, a raised member on the tab or a raised member on the loop, grasping of the tab or raised member allowing expansion of the opening.

10. A method of securing a cell phone during activity comprising:
providing a cell phone holding device of claim 1,
placing the belt around a user's thigh; and
expanding the opening of the loop and inserting a cell-phone containing pocket into the loop.

11. The method of claim 10, further comprising inserting a stopper into the pocket, the stopper sized larger than the opening of the loop, the stopper keeping the pocket in the loop if the cell phone is removed from the pocket.

12. The method of claim 11, wherein the stopper has a slot and is stored on the belt when not in use by the belt engaging the slot.

13. The method of claim 10, wherein the loop has one of a tab on it, a raised member on it or the tab, and the tab or raised member is grasped to open the loop.

14. The device of claim 1, further comprising a pocket adhering material, the pocket adhering material located on an inner surface of the stretchable loop so as to be in contact with a surface of the pocket and adhere a portion of the pocket to the pocket adhering material to facilitate phone removal from the pocket while keeping the pocket in the stretchable loop.

15. The device of claim 1, wherein the pocket adhering material is one of hooks of a hook and loop fastener and a textured material.

16. The method of claim 10, further comprising adhering the pocket to an inside of the stretchable loop using a pocket adhering material located on an inner surface of the stretchable loop.

17. The device of claim 14, wherein the pocket adhering material also functions as the means for expanding.

18. The device of claim 17, wherein the pocket adhering material is a tab, a portion thereof located on the inner surface of the stretchable loop and another portion extending outside of the stretchable loop for grasping purposes.
